(19) United States
(12) Patent Application Publication
(10) Pub. No.: US 2021/0005876 A1
(43) Pub. Date: Jan. 7, 2021

(54) COMPOSITE FOR FORMING ELECTRODE, METHOD OF MANUFACTURING ELECTRODE, AND METHOD OF MANUFACTURING NONAQUEOUS ELECTRIC STORAGE ELEMENT

(71) Applicants: Eiko HIBINO, Kanagawa (JP); Toru USHIROGOCHI, Kanagawa (JP); Toshiya SAGISAKA, Kanagawa (JP); Satoshi NAKAJIMA, Tokyo (JP); Hiromichi KURIYAMA, Kanagawa (JP); Masahiro MASUZAWA, Kanagawa (JP); Keigo TAKAUJI, Kanagawa (JP); Miku OHKIMOTO, Kanagawa (JP); Hiromitsu KAWASE, Kanagawa (JP)

(72) Inventors: Eiko HIBINO, Kanagawa (JP); Toru USHIROGOCHI, Kanagawa (JP); Toshiya SAGISAKA, Kanagawa (JP); Satoshi NAKAJIMA, Tokyo (JP); Hiromichi KURIYAMA, Kanagawa (JP); Masahiro MASUZAWA, Kanagawa (JP); Keigo TAKAUJI, Kanagawa (JP); Miku OHKIMOTO, Kanagawa (JP); Hiromitsu KAWASE, Kanagawa (JP)

(21) Appl. No.: 16/975,968

(22) PCT Filed: Mar. 12, 2019
(86) PCT No.: PCT/JP2019/010100

§ 371 Date: Aug. 26, 2020

(30) Foreign Application Priority Data
Mar. 14, 2018 (JP) 2018-047355
Jan. 11, 2019 (JP) 2019-003695

(51) Int. Cl. H01M 4/131; H01M 4/134; H01M 4/133; H01M 4/1391; H01M 4/1395; H01M 4/1393; H01M 4/583; H01M 4/30; H01M 10/0525

(52) U.S. Cl. CPC H01M 4/131; H01M 4/134; H01M 4/133; H01M 4/1391; H01M 10/0525; H01M 4/1393; H01M 4/583; H01M 4/30; H01M 4/1395

(57) ABSTRACT

A composite for forming an electrode contains an active material and macromolecular particles, and can be discharged by an inkjet method. The composite for forming an electrode is excellent in the storage stability and the discharge stability even when the content of the active material is increased.

### TECHNICAL FIELD

The present disclosure relates to a composite for forming an electrode, a method of manufacturing an electrode, and a method of manufacturing a nonaqueous electric storage element.

### BACKGROUND ART

Lithium-ion secondary batteries have been installed in mobile devices, hybrid vehicles, electric vehicles, and the like, and the demand has been expanding. Also, there is a growing need for thin batteries to be installed on various wearable devices and medical patches, and requirements for lithium-ion secondary batteries have been diversifying.

Conventionally, as a method of manufacturing an electrode of a lithium-ion secondary battery, a method that forms an electrode mixture on an electrode substrate by applying a coating material by using a die coater, a comma coater, a reverse roll coater, or the like, has been known.

The coating material generally has a binder dissolved in an organic solvent or in water and has a viscosity of several thousands to several tens of thousands mPa·s at 25° C.

Meanwhile, a method has also been known that forms an electrode mixture on an electrode substrate by using a composite for forming an electrode that can be discharged by the inkjet method (see, for example, Patent Documents 1 and 2).

The inkjet method is a method of discharging special ink as fine droplets from nozzles on a head, which includes a piezo method, a thermal method, and a valve method depending on the structure of the head for discharging the ink. Among these, the piezo method has advantages such that the amount of ink to be discharged can be precisely controlled by controlling the voltage; influence on the use environment is small because heat is not applied; and the durability is high.

Considering the storage stability and the discharging stability, a composite for forming an electrode that can be discharged by the inkjet method generally has a viscosity of single-digit to several hundreds mPa·s at 25° C., which is smaller than a viscosity of a conventional coating material at 25° C. Also, in order to stably and continuously execute discharging without clogging nozzles on a head, especially when using the piezo method, it is necessary to adjust the viscosity and the surface tension of the composite for forming an electrode to appropriate values.

### SUMMARY OF INVENTION

### Technical Problem

Here, in order to reduce the viscosity of a composite for forming an electrode at 25° C., one may consider reducing the content of a binder. At this time, in order to bind an active material and the electrode substrate and active material by itself, it is necessary to add a certain amount of a binder to the active material, which makes the content of the active material in the composite for forming an electrode smaller.

An object of one embodiment in the present disclosure is to provide a composite for forming an electrode that is excellent in the storage stability and the discharge stability even when the content of an active material is increased.

### Solution to Problem

According to an aspect in the present disclosure, a composite for forming an electrode includes an active material and macromolecular particles, and can be discharged by an inkjet method.

### Advantageous Effects of Invention

According to an aspect in the present disclosure, it is possible to provide a composite for forming an electrode that is excellent in the storage stability and the discharge stability even when the content of an active material is increased.

### BRIEF DESCRIPTION OF DRAWINGS

FIG. 1 is a schematic diagram illustrating an example of an electrode manufactured by a method of manufacturing an electrode according to an embodiment; and

FIG. 2 is a schematic view illustrating an example of a nonaqueous electric storage element manufactured by a method of manufacturing a nonaqueous electric storage element according to an embodiment.

### DESCRIPTION OF EMBODIMENTS

In the following, embodiments for implementing the present inventive concept will be described.

<Composite for Forming Electrode>

A composite for forming an electrode according to the present embodiment contains an active material and macromolecular particles and can be discharged by an inkjet method. Therefore, the composite for forming an electrode according to the present embodiment is excellent in the storage stability and the discharging stability even when the content of the active material is increased.

It is favorable for the composite for forming an electrode according to the present embodiment to further include a dispersion medium. This enables to further improve the storage stability and the discharging stability of the composite for forming an electrode according to the present embodiment.

The content of an active material in a composite for forming an electrode according to the present embodiment is favorably greater than or equal to 10 mass %, and more favorably greater than or equal to 15 mass %. When the content of the active material in the composite for forming an electrode according to the present embodiment is greater than or equal to 10 mass %, the number of times of printing necessary for forming the electrode mixture of a predetermined weight per unit area is reduced.

The viscosity of the composite for forming an electrode at 25° C. according to the present embodiment is favorably less than or equal to 200 mPa·s, and more favorably less than or equal to 50 mPa·s. When the viscosity of the composite for forming an electrode according to the present embodiment at 25° C. is less than or equal to 200 mPa·s, the discharge stability of the composite for forming an electrode is further improved. The viscosity of the composite for forming an electrode according to the present embodiment at 25° C. is normally 10 mPa·s.

<Macromolecular Particles>

As materials that constitute macromolecular particles, thermoplastic resin such as polyvinylidene fluoride, acrylic resin, styrene-butadiene copolymer, polyethylene, polypropylene, polyurethane, nylon, polytetrafluoroethylene, polyphenylene sulfide, polyethylene terephthalate, polybutylene terephthalate, and the like may be listed.

The mass ratio of macromolecular particles to an active material is favorably 1% to 5%, and more favorably 1% to 3%. When the mass ratio of the macromolecular particles to the active material is greater than or equal to 1%, the binding property among the active material itself or between the active material and the electrode substrate are further improved, and when the mass ratio is less than or equal to 5%, the internal resistance of a nonaqueous electric storage element is lowered, and the input/output characteristic of the nonaqueous electric storage element is further improved.

The average particle diameter of the macromolecular particles is favorably 0.01 to 1 m, and more favorably 0.05 to 0.7 μm. When the average particle diameter of the macromolecular particles is greater than or equal to 0.01 μm, the storage stability of the composite for forming an electrode according to the present embodiment is further improved, and when the average particle diameter is less than or equal to 1 μm, the binding property among the active material itself or between the active material and the electrode substrate is further improved.

The melting point of the macromolecular particles is favorably higher than or equal to 120° C., more favorably higher than or equal to 150° C. When the melting point of the macromolecular particles is higher than or equal to 120° C., the macromolecular particles are less likely to melt in a process of drying the composite for forming an electrode according to the present embodiment.

The glass transition temperature of the macromolecular particles is favorably lower than or equal to 100° C., and more favorably lower than or equal to 90° C. When the glass transition temperature at the macromolecular particles is lower than or equal to 100° C., even when the temperature for drying the composite for forming an electrode according to the present embodiment is low, the macromolecular particles tend to more easily function as the binder.

<Dispersion Medium>

The dispersion medium is not limited in particular as long as being capable of dispersing the macromolecular particles without dissolving the macromolecular particles, which may be an aqueous solvent such as water, ethylene glycol, propylene glycol, or the like; an organic solvent such as N-methyl-2-pyrrolidone, cyclohexanone, butyl acetate, mesitylene, 2-n-butoxymethanol, 2-dimethylethanol, N,N-dimethylacetamide, or the like.

Note that among these, one material may be used alone, or two or more may be used together as the dispersion medium.

<Active Material>

As the active material, a positive electrode active material or a negative electrode active material that can be used for an electric storage element such as a lithium-ion secondary battery or the like, may be used.

The positive electrode active material is not limited in particular as long as being capable of reversibly adsorbing and releasing alkali metal ions; for example, an alkali-metal-containing transition metal compound may be used.

As the alkali-metal-containing transition metal compound, for example, a lithium-containing transition metal compound such as a complex oxide containing lithium and one or more elements selected from among a group consisting of cobalt, manganese, nickel, chromium, iron, and vanadium, may be considered.

As the lithium-containing transition metal compound, for example, a lithium-containing transition metal oxide such as lithium cobalt oxide, lithium nickel oxide, lithium manganate, and the like may be listed.

As the alkali-metal-containing transition metal compound, a polyanionic compound having an XO₄ tetrahedron (where X=P, S, As, Mo, W, Si, etc.) in the crystal structure may also be used. Among these, from the viewpoint of the cycle characteristic, a lithium-containing transition metal phosphate compound such as lithium iron phosphate or lithium vanadium phosphate is favorable. In particular, lithium vanadium phosphate has a high lithium diffusion coefficient and is excellent in the output characteristic.

Note that from the viewpoint of electron conductivity, it is favorable for the polyanion-based compound to have its surface covered and compound with a conductive aid such as a carbon material.

The negative electrode active material is not limited in particular as long as being capable of reversibly adsorbing and releasing alkali metal ions; for example, a carbon material containing graphite having a graphite-type crystal structure may be used.

As the carbon material, for example, natural graphite, artificial graphite, non-graphitizable carbon (hard carbon), easily graphitizable carbon (soft carbon), and the like may be listed.

As the negative electrode active material other than the carbon material, for example, lithium titanate, titanium oxide, and the like may be listed.

From the viewpoint of the energy density of the lithium-ion secondary battery, as the negative electrode active material, it is favorable to use a high-capacity material such as silicon, tin, silicon alloy, tin alloy, silicon oxide, silicon nitride, tin oxide, or the like.

Note that when the active material contains lithium, it is favorable that the composite for forming an electrode according to the present embodiment is nonaqueous. In this case, the content of water in the composite for forming an electrode according to the present embodiment is favorably less than or equal to 5 mass %, and more favorably less than or equal to 1 mass %. This enables to prevent lithium contained in the active material from reacting with water to form a compound such as lithium carbonate and to reduce the discharge capacity of the nonaqueous storage element. This also enables, while charging or discharging the nonaqueous electric storage element, to prevent generation of gas due to decomposition of a compound such as lithium carbonate.

The average particle diameter of the active material is favorably less than or equal to 3 μm, and more favorably less than or equal to 1 μm. When the average particle diameter of the active material is less than or equal to 3 μm, the discharge stability and the tolerance to precipitation of the composite for forming an electrode according to the present embodiment are further improved.

The D₁₀ of the active material is favorably greater than or equal to 0.1 μm, and more favorably greater than or equal to 0.15 μm. When the D₁₀ of the active material is greater than or equal to 0.1 μm, the storage stability of the composite for forming an electrode according to the present embodiment is further improved.

The composite for forming an electrode according to the present embodiment may further contain a conductive aid, a dispersing agent, and the like when necessary.

<Conductive Aid>

The conductive aid may be compounded with the active material in advance or may be added when preparing the composite for forming an electrode.

As the conductive aid, for example, conductive carbon black formed by a furnace method, an acetylene method, a gasification method, or the like may be used; other than these, a carbonaceous material such as carbon nanofibers, carbon nanotubes, graphene, graphite particles, or the like may be used.

As a conductive aid other than the carbon material, for example, particles or fibers of metal such as aluminum may be used.

The mass ratio of the conductive aid to the active material is favorably less than or equal to 10%, and more favorably less than or equal to 8%. When the mass ratio of the conductive aid to the active material is less than or equal to 10%, the storage stability of the composite for forming an electrode according to the present embodiment is further improved.

<Dispersing Agent>

The dispersing agent is not limited in particular as long as being capable of improving the dispersibility of an active material, macromolecular particles, and a conductive aid in the dispersion medium; for example, a polymeric dispersing agent such as polycarboxylic acid compound, naphthalenesulfonic acid formalin condensed compound, polyethylene glycol, polycarboxylic acid partial alkyl ester compound, polyether compound, polyalkylene polyamine compound, or the like; a surfactant type dispersing agent such as alkylsulfonic acid type compound, quaternary ammonium salt type compound, higher alcohol alkylene oxide type compound, polyhydric alcohol ester type compound, alkyl polyamine type compound, or the like; an inorganic dispersing agent such as polyphosphate type compound, or the like may be listed.

The dispersing agent may be adsorbed on the surface of the macromolecular particles. Normally, macromolecular particles tend to aggregate when the particle size becomes smaller because the specific surface area increases and the surface energy becomes higher; however, when a dispersing agent is adsorbed on the surface, the particles do not aggregate easily.

Note that the dispersing agent may be appropriately selected depending on the type of the macromolecular particles and the dispersion medium.

For example, in the case of using polyvinylidene fluoride particles as the macromolecular particles, as the dispersing agent, for example, an alkenyl group having 8 to 20 carbon atoms or a nonionic surfactant having an alkyl group having 8 to 20 carbon atoms; and/or polyvinyl pyrrolidone, polypyrrole, polythiophene, polyacrylic acid, polyacrylamide, acrylic acid copolymer, vinylpyridine copolymer, polyethyleneimine, polyvinyl alcohol, polyvinyl ether, carboxymethyl cellulose, hydroxypropylmethyl cellulose, or the like may be used.

In the case of using polyphenylene sulfide particles as the macromolecular particles, as the dispersing agent, for example, polyoxyethylene cumyl phenyl ether as a surfactant having a phenyl group may be used.

<Method of Manufacturing Composite for Forming an Electrode>

A composite for forming an electrode according to the present embodiment can be manufactured by dispersing a composite containing an active material and macromolecular particles in a dispersion medium by using a publicly known method.

<Method of Manufacturing Electrode>

The method of manufacturing an electrode according to the present embodiment includes a process of discharging a composite for forming an electrode according to the present embodiment onto an electrode substrate. At this time, by drying the composite for forming an electrode discharged onto the electrode substrate, an electrode mixture can be formed. The method of manufacturing an electrode according to the present embodiment may further include a process of pressing the electrode substrate onto which the composite for forming an electrode has been discharged.

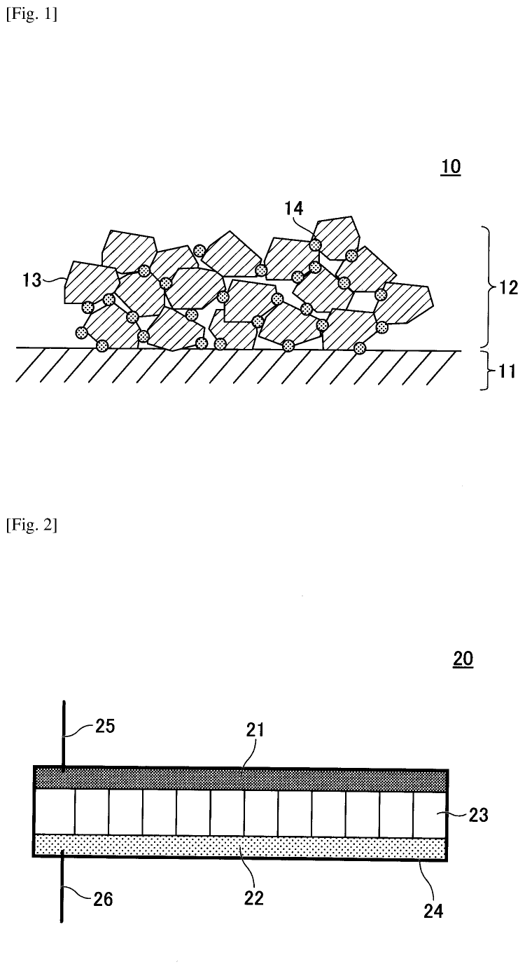

FIG. 1 illustrates an example of an electrode manufactured by the method of manufacturing an electrode according to the present embodiment.

The electrode 10 has an electrode mixture 12 formed on an electrode substrate 11. Here, the electrode mixture 12 contains an active material 13 and macromolecular particles 14, and the macromolecular particles 14 bind the electrode substrate 11 and the active material 13, and the active material 13 itself. Since the electrode mixture 12 contains the macromolecular particles 14, the covered surface area of the active material 13 becomes smaller. Therefore, the resistance of the electrode 10 can be reduced, and the input-output characteristic of the electrode 10 is improved.

<Electrode Substrate>

A material constituting the electrode substrate (current collector) is not limited in particular as long as being conductive and being stable with respect to an applied potential.

As the material constituting the positive electrode substrate, for example, stainless steel, aluminum, titanium, tantalum, and the like may be listed.

As the material constituting the negative electrode substrate, for example, stainless steel, nickel, aluminum, copper, and the like may be listed.

<Method of Manufacturing Nonaqueous Electric Storage Element>

The method of manufacturing a nonaqueous electric storage element according to the present embodiment includes a process of manufacturing an electrode by using the method of manufacturing an electrode according to the present embodiment.

A nonaqueous electric storage element is manufactured to have a predetermined shape by assembling a positive electrode, a negative electrode, a nonaqueous electrolyte, and a separator used when necessary.

The nonaqueous electric storage element may further have constituent members such as an outer can, electrode lead wires, and the like, when necessary.

The method of assembling the positive electrode, the negative electrode, the nonaqueous electrolyte, and the separator when necessary is not limited in particular, and may be appropriately selected from among publicly known methods.

The shape of the nonaqueous electric storage element is not limited in particular, and may be appropriately selected from among publicly known shapes according to its use; for example, a cylinder type in which sheet electrodes and a separator are spirally formed; a cylinder type having an inside-out structure in which pellet electrodes and a separator are combined; a coin type in which pellet electrodes and a separator are laminated; a type using a laminate film exterior in which pellet electrodes and a separator are laminated; and the like may be listed.

FIG. 2 illustrates an example of a nonaqueous electric storage element manufactured by the method of manufacturing a nonaqueous electric storage element according to the present embodiment.

A nonaqueous electric storage element 20 has a positive electrode 21, a negative electrode 22, a separator 23 holding a nonaqueous electrolytic solution, an outer can 24, a lead wire 25 of the positive electrode 21, and a lead wire 26 of the negative electrode 22.

<Nonaqueous Electrolyte>

As the nonaqueous electrolyte, a solid electrolyte or a nonaqueous electrolytic solution may be used.

Here, the nonaqueous electrolytic solution is an electrolytic solution in which an electrolyte salt (in particular, an electrolyte salt containing halogen atoms) is dissolved in a nonaqueous solvent.

<Nonaqueous Solvent>

The nonaqueous solvent is not limited in particular, and may be appropriately selected in accordance with the purpose, but an aprotic organic solvent is favorable.

As the aprotic organic solvent, a carbonate-based organic solvent such as a chain carbonate or a cyclic carbonate may be used. Among these, a chain carbonate is favorable in terms of a high solubility of the electrolyte salt.

Also, it is favorable that the aprotic organic solvent has a low viscosity.

As the chain carbonate, for example, dimethyl carbonate (DMC), diethyl carbonate (DEC), methylethyl carbonate (EMC), and the like may be listed.

Although the content of the chain carbonate in the nonaqueous solvent is not limited in particular and may be appropriately selected in accordance with the purpose, it is favorably greater than or equal to 50 mass %. When the content of the chain carbonate in the nonaqueous solvent is greater than or equal to 50 mass %, even if a solvent other than the chain carbonate is a cyclic substance (e.g., a cyclic carbonate or cyclic ester) having a high dielectric constant, the content of the cyclic substance is relatively low. Therefore, even if a nonaqueous electrolytic solution with a concentration as high as 2 M or greater is manufactured, the viscosity of the nonaqueous electrolytic solution is low, which results in satisfactory penetration of the nonaqueous electrolytic solution into the electrode and in satisfactory ion diffusion.

As the cyclic carbonate, for example, propylene carbonate (PC), ethylene carbonate (EC), butylene carbonate (BC), vinylene carbonate (VC), and the like may be listed.

As a nonaqueous solvent other than the carbonate-based organic solvent, an ester-based organic solvent such as cyclic ester, chain ester, or the like; an ether-based organic solvent such as cyclic ether, chain ether, or the like, may be used when necessary.

As the cyclic ester, for example, γ-butyrolactone (γBL), 2-methyl-γ-butyrolactone, acetyl-γ-butyrolactone, γ-valerolactone, and the like may be listed.

As the chain ester, for example, alkyl ester propionate, dialkyl ester malonate, alkyl ester acetate (methyl acetate (MA), ethyl acetate, etc.), alkyl ester formate (methyl formate (MF), ethyl formate, etc.), and the like may be listed.

As the cyclic ether, for example, tetrahydrofuran, alkyltetrahydrofuran, alkoxytetrahydrofuran, dialkoxytetrahydrofuran, 1,3-dioxolane, alkyl-1,3-dioxolane, 1,4-dioxolane, and the like may be listed.

As the chain ether, for example, 1,2-dimethoxyethane (DME), diethyl ether, ethylene glycol dialkyl ether, diethylene glycol dialkyl ether, triethylene glycol dialkyl ether, tetraethylene glycol dialkyl ether, and the like may be listed.

<Electrolyte Salt>

The electrolyte salt is not limited in particular as long as having a high ionic conductivity and being soluble in a nonaqueous solvent.

It is favorable that the electrolyte salt contains halogen atoms.

As cations constituting the electrolyte salt, for example, lithium ions or the like may be considered.

As anions constituting the electrolyte salt, for example, BF₄⁻, PF₆⁻, AsF₆⁻, CF₃SO₃⁻, (CF₃SO₂)₂N⁻, (C₂FSO₂)₂N⁻, and the like may be listed.

The lithium salt is not limited in particular and may be appropriately selected in accordance with the purpose; for example, lithium hexafluorophosphate (LiPF₆), lithium borofluoride (LiBF₄), lithium arsenic hexafluoride (LiAsF₆), lithium trifluoromethasulfonate (LiCF₃SO₃), lithium bis (trifluoromethylsulfonyl) imide (LiN(CF₃SO₂)₂), lithium (bispentafluoroethylsulfonyl) imide (LiN(C₂FsSO₂)₂), and the like may be listed. Among these, LiPF₆ is favorable from the viewpoint of ion conductivity, and LiBF₄ is favorable from the viewpoint of stability.

Note that among these, one material may be used alone, or two or more may be used together as the electrolyte salt.

The concentration of the electrolyte salt in the nonaqueous electrolytic solution may be appropriately selected in accordance with the purpose; in the case of a swing type electric storage element, it is favorably 1 mol/L to 2 mol/L, or in the case of a reserve type electric storage element, it is favorably 2 mol/L to 4 mol/L.

<Separator>

The separator is provided between the positive electrode and the negative electrode when necessary in order to prevent a short circuit between the positive electrode and the negative electrode.

As the separator, for example, paper such as kraft paper, vinylon mixed paper, and synthetic pulp mixed paper; polyolefin non-woven fabric such as cellophane, polyethylene graft film, polypropylene melt-blown non-woven fabric; polyamide nonwoven fabric; glass fiber non-woven fabric; micropore film; and the like, may be listed.

The size of the separator is not limited in particular as long as being usable for a nonaqueous electric storage element, and may be appropriately selected in accordance with the purpose.

The structure of the separator may be a monolayer structure or a laminate structure.

Note that in the case of using a solid electrolyte as the nonaqueous electrolyte, a separator is not necessary.

<Uses of Nonaqueous Electric Storage Element>

Uses of the nonaqueous electric storage element are not limited in particular and it can be used for various uses; for example, laptop computers, pen-input personal computers, mobile personal computers, electronic book players, mobile phones, portable fax machines, portable copiers, portable printers, headphone stereos, video movie players, liquid crystal televisions, handy cleaners, portable CD players, mini discs, transceivers, electronic diaries, calculators, memory cards, portable tape recorders, radios, backup power supplies, motors, lighting devices, toys, game machines, strobes, cameras, and the like may be listed.

### APPLICATION EXAMPLES

In the following, application examples according to the present embodiment will be described; note that the present inventive concept is not limited to these application examples at all.

The particle-size distribution of active materials prepared by methods as will be described below, and the viscosity and the particle-size distribution of composites for forming an electrode were measured by the following method.

<Particle-Size Distribution of Active Material>

The particle-size distribution of an active material dispersed in water was measured by using a laser-diffraction particle-size distribution measuring device.

<Viscosity of Composite for Forming Electrode>

An E-type viscometer (cone/plate viscometer) having a rotor of No. CPA-40Z attached was used to measure the viscosity of a composite for forming an electrode with 100 rpm at 25° C.

<Particle-Size Distribution of Macromolecular Particles and Composite for Forming Electrode>

The particle-size distribution of macromolecular particles dispersed in a main dispersion medium and a composite for forming an electrode was measured by using a laser-diffraction particle-size distribution measuring device.

<Manufacture of Positive-Electrode Active Material (1)>

Vanadium pentoxide, lithium hydroxide, phosphoric acid, sucrose, and water were mixed to be precipitated, sprayed by a spray dryer to be dried, and then, crushed by a jet mill, to obtain a precursor of lithium vanadium phosphate (Li₃V₂(PO₄)₃) particles. Next, in a nitrogen atmosphere, at 900° C., the precursor of lithium vanadium phosphate particles was calcined to obtain lithium vanadium phosphate particles having a carbon content of 3 mass %. Further, the lithium vanadium phosphate particles were crushed by a jet mill so that the D₉₀ became less than 3 μm, to obtain a positive electrode active material (1) having a peak in the particle-size distribution at 0.7 μm.

<Manufacture of Positive-Electrode Active Material (2)>

Lithium iron phosphate (LiFePO₄) particles (manufactured by Sigma-Aldrich Co.) were crushed by a jet mill so that the D₉₀ became less than 3 μm, to obtain a positive electrode active material (2) having a peak in the particle-size distribution at 0.6 μm.

<Manufacture of Positive-Electrode Active Material (3)>

Lithium cobalt oxide (LiCoO₂) particles (manufactured by Sigma-Aldrich Co.) were crushed by a jet mill so that the D₉₀ became less than 3 μm, to obtain a positive electrode active material (3) having a peak in the particle-size distribution at 0.9 μm.

<Manufacture of Positive-Electrode Active Material (4)>

Lithium nickelate (LiNi_{0.8}Co_{0.15}Al_{0.05}O₂) particles (manufactured by Sigma-Aldrich Co.) were crushed by a jet mill so that the D₉₀ became less than 3 μm, to obtain a positive electrode active material (4) having a peak in the particle-size distribution at 1.2 μm.

<Manufacture of Positive-Electrode Active Material (5)>

Ni—Mn—Co (LiNi_{1/3}Mn_{1/3}Co_{1/3}O₂) based particles (manufactured by Sigma-Aldrich Co.) were crushed by a jet mill so that the D₉₀ became less than 3 μm, to obtain a positive electrode active material (5) having a peak in the particle-size distribution at 0.9 μm.

<Manufacture of Positive-Electrode Active Material (6)>

Lithium manganate (LiMn₂O₄) particles (manufactured by Sigma-Aldrich Co.) were crushed by a jet mill so that the D₉₀ became less than 3 μm, to obtain a positive electrode active material (6) having a peak in the particle-size distribution at 1.2 μm.

<Manufacture of Negative Electrode Active Material (1)>

Artificial graphite (manufactured by MT-Carbon Corp.) was crushed by a jet mill so that the D₉₀ became less than 3 μm, to obtain a negative electrode active material (1) having a peak in the particle-size distribution at 1.8 μm.

<Manufacture of Negative Electrode Active Material (2)>

Lithium titanate (Li₄Ti₅O₁₂) particles (manufactured by Sigma-Aldrich Co.) were crushed by a jet mill so that the D₉₀ became less than 3 μm, to obtain a negative electrode active material (2) having a peak in the particle-size distribution at 0.7 μm.

Table 1 lists the species of active materials.

TABLE 1

| | Species |
|---|---|
| Positive electrode | Lithium vanadium phosphate |
| active material (1) | |
| Positive electrode | Lithium iron phosphate |
| active material (2) | |
| Positive electrode | Lithium cobaltate |
| active material (3) | |
| Positive electrode | Lithium nickelate |
| active material (4) | |
| Positive electrode | Ni—Mn—Co based |
| active material (5) | |
| Positive electrode | Lithium manganate |
| active material (6) | |
| Negative electrode | Artificial graphite |
| active material (1) | |
| Negative electrode | Lithium titanate |
| active material (2) | |

### Application Example 1

A composite for forming a positive electrode was prepared by mixing 25 mass % of the positive electrode active material (1); 5 mass % of Toraypearl™ PVDF (manufactured by Toray Industries, Inc.) as an aqueous dispersion of 20 mass % of polyvinylidene fluoride (PVDF) particles having an average particle diameter of 0.5 μm and a melting point at 151° C.; and 70 mass % of a mixed solution of ion-exchanged water and propylene glycol (mass ratio of 7:3).

Here, as being insoluble in water and in propylene glycol, polyvinylidene fluoride exists as particles in the composite for forming a positive electrode, and the mixed solution of water and propylene glycol functions as a dispersion medium.

The viscosity of the composite for forming a positive electrode was 15 mPa·s.

The particle-size distribution of the composite for forming a positive electrode was measured, and it was found that the distribution had a peak at 0.7 μm and the D₉₀ was 2.9 μm. After 24 hours, the particle-size distribution of the composite for forming a positive electrode was measured again; no change was observed in the particle-size distribution, and the storage stability of the composite for forming a positive electrode was satisfactory.

The composite for forming a positive electrode was printed on aluminum foil as a positive electrode substrate, by using an ink-jet printer EV2500 (manufactured by Ricoh Co., Ltd.). At this time, it was possible to continuously discharge the composite for forming a positive electrode, and the discharge stability of the composite for forming a positive electrode was satisfactory. Also, by printing the composite for forming a positive electrode eight times, it was possible to form a coating film corresponding to around 2.5 mg/cm² of a positive electrode mixture, and the printing efficiency of the composite for forming a positive electrode was satisfactory.

The aluminum foil having the coating film formed was placed in a dryer at 120° C. for five minutes to dry and remove the solvent, and then, pressed by a roll press machine having the roll temperature set at 90° C. to form a positive electrode mixture so as to prepare a positive electrode.

Next, the positive electrode was immersed in propylene carbonate as a nonaqueous solvent used in a nonaqueous electric storage element, to evaluate the adhesion of the positive electrode mixture; no floating or peeling of the positive electrode mixture was observed, and the positive electrode mixture stuck firmly on the aluminum foil. Thus, it was confirmed that the polyvinylidene fluoride particles function as a binder.

### Application Example 2

A composite for forming a positive electrode was prepared by mixing 25 mass % of the positive electrode active material (1); 2 mass % of an aqueous dispersion of 50 mass % of acrylic resin particles having an average particle diameter of 0.15 μm and a glass transition temperature at −61° C.; and 73 mass % of a mixed solution of ion-exchanged water and propylene glycol (mass ratio of 7:3).

Here, as being insoluble in water and in propylene glycol, acrylic resin exists as particles in the composite for forming a positive electrode, and the mixed solution of water and propylene glycol functions as a dispersion medium.

The viscosity of the composite for forming a positive electrode was 16 mPa·s.

The particle-size distribution of the composite for forming a positive electrode was measured, and it was found that the distribution had a peak at 0.7 μm and the D₉₀ was 3.1 μm. After 24 hours, the particle-size distribution of the composite for forming a positive electrode was measured again; no change was observed in the particle-size distribution, and the storage stability of the composite for forming a positive electrode was satisfactory.

The composite for forming a positive electrode was printed on aluminum foil as a positive electrode substrate, by using an ink-jet printer EV2500 (manufactured by Ricoh Co., Ltd.). At this time, it was possible to continuously discharge the composite for forming a positive electrode, and the discharge stability of the composite for forming a positive electrode was satisfactory. Also, by printing the composite for forming a positive electrode eight times, it was possible to form a coating film corresponding to around 2.5 mg/cm² of the positive electrode mixture, and the printing efficiency of the composite for forming a positive electrode was satisfactory.

The aluminum foil having the coating film formed was placed in a dryer at 120° C. for five minutes to dry and remove the solvent, and then, pressed by a roll press machine at room temperature to form a positive electrode mixture so as to prepare a positive electrode.

Next, the positive electrode was immersed in propylene carbonate as a nonaqueous solvent used in a nonaqueous electric storage element, to evaluate the adhesion of the positive electrode mixture; no floating or peeling of the positive electrode mixture was observed, and the positive electrode mixture stuck firmly on the aluminum foil. Thus, it was confirmed that the particles of acrylic resin function as a binder.

### Application Example 3

A composite for forming a negative electrode was prepared by mixing 15 mass % of the negative electrode active material (1); 1 mass % of BM-400B (manufactured by Nippon Zeon Co., Ltd.) as an aqueous dispersion of 50 mass % of styrene-butadiene copolymer particles having an average particle diameter of 0.15 μm and a glass transition temperature at −5° C.; 0.01 mass % of TRITON X-100 (manufactured by Sigma-Aldrich Co.) as a dispersing agent; and 83.9 mass % of a mixed solution of ion-exchanged water and propylene glycol (mass ratio of 7:3).

Here, as being insoluble in water and in propylene glycol, styrene-butadiene copolymer exists as particles in the composite for forming a negative electrode, and the mixed solution of water and propylene glycol functions as a dispersion medium.

The viscosity of the composite for forming a negative electrode was 14 mPa·s.

The particle-size distribution of the composite for forming a positive electrode was measured, and it was found that the distribution had a peak at 1.8 μm and the D₉₀ was 3.2 μm. After 24 hours, the particle-size distribution of the composite for forming a negative electrode was measured again; no change was observed in the particle-size distribution, and the storage stability of the composite for forming a negative electrode was satisfactory.

The composite for forming a negative electrode was printed on copper foil serving as a negative electrode substrate, by using an ink-jet printer EV2500 (manufactured by Ricoh Co., Ltd.). At this time, it was possible to continuously discharge the composite for forming a negative electrode, and the discharge stability of the composite for forming a negative electrode was satisfactory. Also, by printing the composite for forming a negative electrode eight times, it was possible to form a coating film corresponding to around 1.5 mg/cm² of the negative electrode mixture, and the printing efficiency of the composite for forming a negative electrode was satisfactory.

The copper foil having the coating film formed was placed in a dryer at 120° C. for five minutes to dry and remove the solvent, and then, pressed with a roll press machine at room temperature to form a negative electrode mixture so as to prepare a negative electrode.

Next, the negative electrode was immersed in propylene carbonate as a nonaqueous solvent used in a nonaqueous electric storage element, to evaluate the adhesion of the negative electrode mixture; no floating or peeling of the negative electrode mixture was observed, and the negative electrode mixture stuck firmly on the copper foil. Thus, it was confirmed that the styrene-butadiene copolymer particles function as a binder.

### Comparative Example 1

Carboxymethylcellulose sodium called CMC Daicel 1220 (manufactured by Daicel FineChem Ltd.) was dissolved in water to obtain an aqueous solution of 1 mass % of sodium carboxymethylcellulose. The viscosity of the aqueous solution of 1 mass % of sodium carboxymethylcellulose was 20 mPa·s.

A composite for forming a positive electrode was prepared by mixing 25 mass % of the positive electrode active material (1) and 75 mass % of the aqueous solution of 1 mass % of sodium carboxymethylcellulose.

The viscosity of the composite for forming a positive electrode was 18 mPa·s.

The particle-size distribution of the composite for forming a positive electrode was measured, and it was found that the distribution had a peak at 0.7 μm and the D₉₀ was 4.5 μm. After 24 hours, the particle-size distribution of the composite for forming a positive electrode was measured again; the height of the peak decreased, a new peak appeared at 11 μm, and the D₉₀ was 25 μm. For this reason, the storage stability of the composite for forming a positive electrode was inadequate.

The composite for forming a positive electrode was printed on aluminum foil as a positive electrode substrate, by using an ink-jet printer EV2500 (manufactured by Ricoh Co., Ltd.). At this time, immediately after the start of printing, discharge defects were found in some nozzles, and as the printing continued, the number of discharge-defective nozzles continued to increase. For this reason, the discharge stability of the composite for forming a positive electrode was inadequate.

### Comparative Example 2

Carboxymethylcellulose sodium called CMC Daicel 1220 (manufactured by Daicel FineChem Ltd.) was dissolved in water to obtain an aqueous solution of 1 mass % of sodium carboxymethylcellulose. The viscosity of an aqueous solution of 1 mass % of carboxymethylcellulose sodium was 20 mPa·s.

A composite for forming a positive electrode was prepared by mixing 5 mass % of the positive electrode active material (1); 15 mass % of the aqueous solution of 1 mass % of the carboxymethylcellulose sodium; and 80 mass % of a mixed solution of ion-exchanged water and propylene glycol (mass ratio of 7:3).

The viscosity of the composite for forming a positive electrode was 12 mPa·s.

The particle-size distribution of the composite for positive electrode formation was measured, and it was found that the distribution had a peak at 0.7 μm and the D₉₀ was 3.7 μm. After 24 hours, the particle-size distribution of the composite for forming a positive electrode was measured again; no change was observed in the particle-size distribution, and the storage stability of the composite for forming a positive electrode was satisfactory.

The composite for forming a positive electrode was printed on aluminum foil as a positive electrode substrate, by using an ink-jet printer EV2500 (manufactured by Ricoh Co., Ltd.). At this time, it was possible to continuously discharge the composite for forming a positive electrode, and the discharge stability of the composite for forming a positive electrode was satisfactory. However, even after the composite for forming a positive electrode had been printed eight times, a coating film corresponding to a positive electrode mixture of only 0.5 mg/cm² was formed, and the printing efficiency of the composite for forming a positive electrode was inadequate.

### Application Example 4

A composite for forming a positive electrode was prepared by mixing 25 mass % of the positive electrode active material (1); 5 mass % of Toraypearl™ PPS (manufactured by Toray Industries, Inc.) as an aqueous dispersion of 10 mass % of polyphenylene sulfide (PPS) particles having an average particle diameter of 0.5 μm, a glass transition temperature at 85° C., and a melting point at 285° C.; and 70 mass % of cyclohexanone.

Here, as being insoluble in water and in cyclohexanone, polyphenylene sulfide exists as particles in the composite for forming a positive electrode, and the mixed solution of water and cyclohexanone functions as a dispersion medium. Also, the polyphenylene sulfide particles are dispersed in water because polyoxyethylene cumyl phenyl ether is used as a dispersing agent.

The viscosity of the composite for forming a positive electrode was 14 mPa·s.

The particle-size distribution of the composite for forming a positive electrode was measured, and it was found that the distribution had a peak at 0.7 μm and the D₉₀ was 2.9 μm. After 24 hours, the particle-size distribution of the composite for forming a positive electrode was measured again; no change was observed in the particle-size distribution, and the storage stability of the composite for forming a positive electrode was satisfactory.

The composite for forming a positive electrode was printed on aluminum foil as a positive electrode substrate, by using an ink-jet printer EV2500 (manufactured by Ricoh Co., Ltd.). At this time, it was possible to continuously discharge the composite for forming a positive electrode, and the discharge stability of the composite for forming a positive electrode was satisfactory. Also, by printing the composite for forming a positive electrode eight times, it was possible to form a coating film corresponding to around 2.5 mg/cm² of the positive electrode mixture, and the printing efficiency of the composite for forming a positive electrode was satisfactory.

The aluminum foil having the coating film formed was placed in a dryer at 120° C. for five minutes to dry and remove the solvent, and then, pressed by a roll press machine having the roll temperature set at 150° C. to form a positive electrode mixture so as to prepare a positive electrode.

Next, the positive electrode was immersed in propylene carbonate as a nonaqueous solvent used in a nonaqueous electric storage element, to evaluate the adhesion of the positive electrode mixture; no floating or peeling of the positive electrode mixture was observed, and the positive electrode mixture stuck firmly on the aluminum foil. Thus, it was confirmed that the polyphenylene sulfide particles function as a binder.

### Application Example 5

A composite for forming a positive electrode was prepared in virtually the same way as in Application example 4 except that N-methyl-2-pyrrolidone (NMP) was used instead of cyclohexanone.

Here, as being insoluble in water and in NMP, polyphenylene sulfide exists as particles in the composite for forming a positive electrode, and the mixed solution of water and NMP functions as a dispersion medium.

The viscosity of the composite for forming a positive electrode was 13 mPa·s.

The particle-size distribution of the composite for forming a positive electrode was measured, and it was found that the distribution had a peak at 0.7 μm and the D₉₀ was 2.9 μm. After 24 hours, the particle-size distribution of the composite for forming a positive electrode was measured again; no change was observed in the particle-size distribution, and the storage stability of the composite for forming a positive electrode was satisfactory.

The composite for forming a positive electrode was printed on aluminum foil as a positive electrode substrate, by using an ink-jet printer EV2500 (manufactured by Ricoh Co., Ltd.). At this time, it was possible to continuously discharge the composite for forming a positive electrode, and the discharge stability of the composite for forming a positive electrode was satisfactory. Also, by printing the composite for forming a positive electrode eight times, it was possible to form a coating film corresponding to around 2.5 mg/cm² of the positive electrode mixture, and the printing efficiency of the composite for forming a positive electrode was satisfactory.

The aluminum foil having the coating film formed was placed in a dryer at 120° C. for five minutes to dry and remove the solvent, and then, pressed by a roll press machine having the roll temperature set at 150° C. to form a positive electrode mixture so as to prepare a positive electrode.

Next, the positive electrode was immersed in propylene carbonate as a nonaqueous solvent used in a nonaqueous electric storage element, to evaluate the adhesion of the positive electrode mixture; no floating or peeling of the positive electrode mixture was observed, and the positive electrode mixture stuck firmly on the aluminum foil. Thus, it was confirmed that the polyphenylene sulfide particles function as a binder.

### Application Example 6

A composite for forming a positive electrode was prepared in virtually the same way as in Application example 4 except that Toraypearl™ PBT (manufactured by Toray Industries, Inc.) as an aqueous dispersion of 10 mass % of polybutylene terephthalate (PBT) particles having an average particle diameter of 0.5 μm, a glass transition temperature at 34° C., and a melting point at 224° C. was used instead of Toraypearl™ PPS (manufactured by Toray Industries, Inc.).

Here, as being insoluble in water and in cyclohexanone, polybutylene terephthalate exists as particles in the composite for forming a positive electrode, and the mixed solution of water and cyclohexanone functions as a dispersion medium.

The viscosity of the composite for forming a positive electrode was 10 mPa·s.

The particle-size distribution of the composite for forming a positive electrode was measured, and it was found that the distribution had a peak at 0.7 μm and the D₉₀ was 2.9 μm. After 24 hours, the particle-size distribution of the composite for forming a positive electrode was measured again; no change was observed in the particle-size distribution, and the storage stability of the composite for forming a positive electrode was satisfactory.

The composite for forming a positive electrode was printed on aluminum foil as a positive electrode substrate, by using an ink-jet printer EV2500 (manufactured by Ricoh Co., Ltd.). At this time, it was possible to continuously discharge the composite for forming a positive electrode, and the discharge stability of the composite for forming a positive electrode was satisfactory. Also, by printing the composite for forming a positive electrode eight times, it was possible to form a coating film corresponding to around 2.5 mg/cm² of the positive electrode mixture, and the printing efficiency of the composite for forming a positive electrode was satisfactory.

The aluminum foil having the coating film formed was placed in a dryer at 120° C. for five minutes to dry and remove the solvent, and then, pressed by a roll press machine having the roll temperature set at 90° C. to form a positive electrode mixture so as to prepare a positive electrode.

Next, the positive electrode was immersed in propylene carbonate as a nonaqueous solvent used in a nonaqueous electric storage element, to evaluate the adhesion of the positive electrode mixture; no floating or peeling of the positive electrode mixture was observed, and the positive electrode mixture stuck firmly on the aluminum foil. Thus, it was confirmed that the polybutylene terephthalate particles function as a binder.

### Application Example 7

A composite for forming a positive electrode was prepared in virtually the same way as in Application example 4 except that 3-methoxy-N,N-dimethylpropionamide was used instead of cyclohexanone.

Here, as being insoluble in water and in 3-methoxy-N,N-dimethylpropionamide, polyphenylene sulfide exists as particles in the composite for forming a positive electrode, and the mixed solution of water and 3-methoxy-N,N-dimethylpropionamide functions as a dispersion medium.

The viscosity of the composite for forming a positive electrode was 12 mPa·s.

The particle-size distribution of the composite for forming a positive electrode was measured, and it was found that the distribution had a peak at 0.7 μm and the D₉₀ was 2.9 μm. After 24 hours, the particle-size distribution of the composite for forming a positive electrode was measured again; no change was observed in the particle-size distribution, and the storage stability of the composite for forming a positive electrode was satisfactory.

The composite for forming a positive electrode was printed on aluminum foil as a positive electrode substrate, by using an ink-jet printer EV2500 (manufactured by Ricoh Co., Ltd.). At this time, it was possible to continuously discharge the composite for forming a positive electrode, and the discharge stability of the composite for forming a positive electrode was satisfactory. Also, by printing the composite for forming a positive electrode eight times, it was possible to form a coating film corresponding to around 2.5 mg/cm² of the positive electrode mixture, and the printing efficiency of the composite for forming a positive electrode was satisfactory.

The aluminum foil having the coating film formed was placed in a dryer at 120° C. for five minutes to dry and remove the solvent, and then, pressed by a roll press machine having the roll temperature set at 150° C. to form a positive electrode mixture so as to prepare a positive electrode.

Next, the positive electrode was immersed in propylene carbonate as a nonaqueous solvent used in a nonaqueous electric storage element, to evaluate the adhesion of the positive electrode mixture; no floating or peeling of the positive electrode mixture was observed, and the positive electrode mixture stuck firmly on the aluminum foil. Thus, it was confirmed that the polyphenylene sulfide particles function as a binder.

### Comparative Example 3

A composite for forming a positive electrode was prepared in virtually the same way as in Application example 6 except that NMP was used instead of cyclohexanone.

Here, as being soluble in NMP, polybutylene terephthalate does not exist as particles in the composite for forming a positive electrode.

The viscosity of the composite for forming a positive electrode was 14 mPa·s.

The particle-size distribution of the composite for forming a positive electrode was measured, and it was found that the distribution had a peak at 0.7 μm and the D₉₀ of 4.5 m. After 24 hours, the particle-size distribution of the composite for forming a positive electrode was measured again; the height of the peak decreased, a new peak appeared at 11 μm, and the D₉₀ was 25 μm. For this reason, the storage stability of the composite for forming a positive electrode was inadequate.

The composite for forming a positive electrode was printed on aluminum foil as a positive electrode substrate, by using an ink-jet printer EV2500 (manufactured by Ricoh Co., Ltd.). At this time, immediately after the start of printing, discharge defects were found in some nozzles, and as the printing continued, the number of discharge-defective nozzles continued to increase. For this reason, the discharge stability of the composite for forming a positive electrode was inadequate.

### Comparative Example 4

A composite for forming a positive electrode was prepared by mixing 10 mass % of the positive electrode active material (1); 0.3 mass % of polyvinylidene fluoride called Solef 5130 (manufactured by Solvay); and 89.7 mass % of NMP

Here, polyvinylidene fluoride is soluble in NMP.

The viscosity of the composite for forming a positive electrode was 11 mPa·s.

The particle-size distribution of the composite for forming a positive electrode was measured, and it was found that the distribution had a peak at 0.7 μm and the D₉₀ of 4.5 m. After 24 hours, the particle-size distribution of the composite for forming a positive electrode was measured again; the height of the peak decreased, a new peak appeared at 11 μm, and the D₉₀ was 25 μm. For this reason, the storage stability of the composite for forming a positive electrode was inadequate.

The composite for forming a positive electrode was printed on aluminum foil as a positive electrode substrate, by using an ink-jet printer EV2500 (manufactured by Ricoh Co., Ltd.). At this time, immediately after the start of printing, discharge defects were found in some nozzles, and as the printing continued, the number of discharge-defective nozzles continued to increase. For this reason, the discharge stability of the composite for forming a positive electrode was inadequate.

<Manufacture of NMP Dispersion of 5 Mass % of Polyphenylene Sulfide Particles>

Toraypearl™ PPS (manufactured by Toray Industries, Inc.) as an aqueous dispersion of 10 mass % of polyphenylene sulfide particles is added with polyoxyethylene cumyl phenyl ether in order to disperse polyphenylene sulfide particles in water.

In order to replace the water contained in Toraypearl™ PPS (manufactured by Toray Industries, Inc.) with NMP, a minute amount of an alcohol component whose boiling point is higher than or equal to the boiling point of water (100° C.) and lower than or equal to the boiling point of NMP (202° C.), and a predetermined amount of NMP were added to a predetermined amount of Toraypearl™ PPS (manufactured by Toray Industries, Inc.) are added, to perform the replacement by decompression.

Specifically, 5 g of Toraypearl™ PPS (manufactured by Toray Industries, Inc.), 0.5 g of 2-ethoxyethanol, and 95 g of NMP were added into an eggplant flask, and then, the flask was installed on a rotary evaporator. Next, water and 2-ethoxyethanol were evaporated under conditions of 70° C. and 20 mmHg, followed by ultrasonic treatment. Next, it was filtered through a filter paper called No. 5B made by Kiriyama glass CO., to retain particles of 4 μm, to obtain an NMP dispersion of polyphenylene sulfide particles. The NMP dispersion of the polyphenylene sulfide particles had a solid content concentration of approximately 5 mass %. Also, the NMP dispersion of the polyphenylene sulfide particles had an average particle diameter of 0.4 μm.

Here, it can be considered that polyoxyethylene cumyl phenyl ether contained in the aqueous dispersion of the polyphenylene sulfide particles is also contained in the NMP dispersion.

### Application Example 8

A composite for forming a positive electrode was prepared by mixing 25 mass % of the positive electrode active material (1); 15 mass % of an NMP dispersion of 5 mass % of polyphenylene sulfide particles; 5 mass % of an NMP dispersion of 20 mass % of carbon black (manufactured by Mikuni-Color Ltd.) as a conductive aid; and 55 mass % of a mixed solution of NMP and propylene glycol (mass ratio of 7:3).

Here, as being insoluble in NMP and in propylene glycol, polyphenylene sulfide exists as particles in the composite for forming a positive electrode, and the mixed solution of NMP and propylene glycol functions as a dispersion medium.

The viscosity of the composite for forming a positive electrode was 14 mPa·s.

The particle-size distribution of the composite for positive electrode formation was measured, and it was found that the distribution had a peak at 0.7 μm and the D₉₀ was 1.8 μm. After 24 hours, the particle-size distribution of the composite for forming a positive electrode was measured again; no change was observed in the particle-size distribution, and the storage stability of the composite for forming a positive electrode was satisfactory.

The composite for forming a positive electrode was printed on aluminum foil as a positive electrode substrate, by using an ink-jet printer EV2500 (manufactured by Ricoh Co., Ltd.). At this time, it was possible to continuously discharge the composite for forming a positive electrode, and the discharge stability of the composite for forming a positive electrode was satisfactory. Also, by printing the composite for forming a positive electrode eight times, it was possible to form a coating film corresponding to around 2.5 mg/cm² of the positive electrode mixture, and the printing efficiency of the composite for forming a positive electrode was satisfactory.

The aluminum foil having the coating film formed was placed in a dryer at 120° C. for five minutes to dry and remove the solvent, and then, pressed by a roll press machine at room temperature to form a positive electrode mixture so as to prepare a positive electrode.

Next, the positive electrode was immersed in propylene carbonate as a nonaqueous solvent used in a nonaqueous electric storage element, to evaluate the adhesion of the positive electrode mixture; no floating or peeling of the positive electrode mixture was observed, and the positive electrode mixture stuck firmly on the aluminum foil. Thus, it was confirmed that the polyphenylene sulfide particles function as a binder.

### Application Example 9

A composite for forming a positive electrode was prepared in virtually the same way as in Application example 8 except that the positive electrode active material (2) was used instead of the positive electrode active material (1).

The viscosity of the composite for forming a positive electrode was 16 mPa·s.

The particle-size distribution of the composite for positive electrode formation was measured, and it was found that the distribution had a peak at 0.6 μm and the D₉₀ was 1.5 μm. After 24 hours, the particle-size distribution of the composite for forming a positive electrode was measured again; no change was observed in the particle-size distribution, and the storage stability of the composite for forming a positive electrode was satisfactory.

The composite for forming a positive electrode was printed on aluminum foil as a positive electrode substrate, by using an ink-jet printer EV2500 (manufactured by Ricoh Co., Ltd.). At this time, it was possible to continuously discharge the composite for forming a positive electrode, and the discharge stability of the composite for forming a positive electrode was satisfactory. Also, by printing the composite for forming a positive electrode eight times, it was possible to form a coating film corresponding to around 2.5 mg/cm² of the positive electrode mixture, and the printing efficiency of the composite for forming a positive electrode was satisfactory.

The aluminum foil having the coating film formed was placed in a dryer at 120° C. for five minutes to dry and remove the solvent, and then, pressed by a roll press machine at room temperature to form a positive electrode mixture so as to prepare a positive electrode.

Next, the positive electrode was immersed in propylene carbonate as a nonaqueous solvent used in a nonaqueous electric storage element, to evaluate the adhesion of the positive electrode mixture; no floating or peeling of the positive electrode mixture was observed, and the positive electrode mixture stuck firmly on the aluminum foil. Thus, it was confirmed that the polyphenylene sulfide particles function as a binder.

### Application Example 10

A composite for forming a positive electrode was prepared in virtually the same way as in Application example 8 except that the positive electrode active material (3) was used instead of the positive electrode active material (1).

The viscosity of the composite for forming a positive electrode was 13 mPa·s.

The particle-size distribution of the composite for positive electrode formation was measured, and it was found that the distribution had a peak at 0.9 μm and the D₉₀ was 1.7 μm. After 24 hours, the particle-size distribution of the composite for forming a positive electrode was measured again; no change was observed in the particle-size distribution, and the storage stability of the composite for forming a positive electrode was satisfactory.

The composite for forming a positive electrode was printed on aluminum foil as a positive electrode substrate, by using an ink-jet printer EV2500 (manufactured by Ricoh Co., Ltd.). At this time, it was possible to continuously discharge the composite for forming a positive electrode, and the discharge stability of the composite for forming a positive electrode was satisfactory. Also, by printing the composite for forming a positive electrode eight times, it was possible to form a coating film corresponding to around 2.5 mg/cm² of the positive electrode mixture, and the printing efficiency of the composite for forming a positive electrode was satisfactory.

The aluminum foil having the coating film formed was placed in a dryer at 120° C. for five minutes to dry and remove the solvent, and then, pressed by a roll press machine at room temperature to form a positive electrode mixture so as to prepare a positive electrode.

Next, the positive electrode was immersed in propylene carbonate as a nonaqueous solvent used in a nonaqueous electric storage element, to evaluate the adhesion of the positive electrode mixture; no floating or peeling of the positive electrode mixture was observed, and the positive electrode mixture stuck firmly on the aluminum foil. Thus, it was confirmed that the polyphenylene sulfide particles function as a binder.

### Application Example 11

A composite for forming a positive electrode was prepared in virtually the same way as in Application example 8 except that the positive electrode active material (4) was used instead of the positive electrode active material (1).

The viscosity of the composite for forming a positive electrode was 10 mPa·s.

The particle-size distribution of the composite for forming a positive electrode was measured, and it was found that the distribution had a peak at 1.2 μm and the D₉₀ was 2.1 μm. After 24 hours, the particle-size distribution of the composite for forming a positive electrode was measured again; no change was observed in the particle-size distribution, and the storage stability of the composite for forming a positive electrode was satisfactory.

The composite for forming a positive electrode was printed on aluminum foil as a positive electrode substrate, by using an ink-jet printer EV2500 (manufactured by Ricoh Co., Ltd.). At this time, it was possible to continuously discharge the composite for forming a positive electrode, and the discharge stability of the composite for forming a positive electrode was satisfactory. Also, by printing the composite for forming a positive electrode eight times, it was possible to form a coating film corresponding to around 2.5 mg/cm² of the positive electrode mixture, and the printing efficiency of the composite for forming a positive electrode was satisfactory.

The aluminum foil having the coating film formed was placed in a dryer at 120° C. for five minutes to dry and remove the solvent, and then, pressed by a roll press machine at room temperature to form a positive electrode mixture so as to prepare a positive electrode.

Next, the positive electrode was immersed in propylene carbonate as a nonaqueous solvent used in a nonaqueous electric storage element, to evaluate the adhesion of the positive electrode mixture; no floating or peeling of the positive electrode mixture was observed, and the positive electrode mixture stuck firmly on the aluminum foil. Thus, it was confirmed that the polyphenylene sulfide particles function as a binder.

### Application Example 12

A composite for forming a positive electrode was prepared in virtually the same way as in Application example 8 except that the positive electrode active material (5) was used instead of the positive electrode active material (1).

The viscosity of the composite for forming a positive electrode was 12 mPa·s.

The particle-size distribution of the composite for forming a positive electrode was measured, and it was found that the distribution had a peak at 0.9 μm and the D₉₀ was 1.8 μm. After 24 hours, the particle-size distribution of the composite for forming a positive electrode was measured again; no change was observed in the particle-size distribution, and the storage stability of the composite for forming a positive electrode was satisfactory.

The composite for forming a positive electrode was printed on aluminum foil as a positive electrode substrate, by using an ink-jet printer EV2500 (manufactured by Ricoh Co., Ltd.). At this time, it was possible to continuously discharge the composite for forming a positive electrode, and the discharge stability of the composite for forming a positive electrode was satisfactory. Also, by printing the composite for forming a positive electrode eight times, it was possible to form a coating film corresponding to around 2.5 mg/cm² of the positive electrode mixture, and the printing efficiency of the composite for forming a positive electrode was satisfactory.

The aluminum foil having the coating film formed was placed in a dryer at 120° C. for five minutes to dry and remove the solvent, and then, pressed by a roll press machine at room temperature to form a positive electrode mixture so as to prepare a positive electrode.

Next, the positive electrode was immersed in propylene carbonate as a nonaqueous solvent used in a nonaqueous electric storage element, to evaluate the adhesion of the positive electrode mixture; no floating or peeling of the positive electrode mixture was observed, and the positive electrode mixture stuck firmly on the aluminum foil. Thus, it was confirmed that the polyphenylene sulfide particles function as a binder.

### Application Example 13

A composite for forming a positive electrode was prepared in virtually the same way as in Application example 8 except that the positive electrode active material (6) was used instead of the positive electrode active material (1).

The viscosity of the composite for forming a positive electrode was 11 mPa·s.

The particle-size distribution of the composite for positive electrode formation was measured, and it was found that the distribution had a peak at 1.2 μm and the D₉₀ was 2.3 μm. After 24 hours, the particle-size distribution of the composite for forming a positive electrode was measured again; no change was observed in the particle-size distribution, and the storage stability of the composite for forming a positive electrode was satisfactory.

The composite for forming a positive electrode was printed on aluminum foil as a positive electrode substrate, by using an ink-jet printer EV2500 (manufactured by Ricoh Co., Ltd.). At this time, it was possible to continuously discharge the composite for forming a positive electrode, and the discharge stability of the composite for forming a positive electrode was satisfactory. Also, by printing the composite for forming a positive electrode eight times, it was possible to form a coating film corresponding to around 2.5 mg/cm² of the positive electrode mixture, and the printing efficiency of the composite for forming a positive electrode was satisfactory.

The aluminum foil having the coating film formed was placed in a dryer at 120° C. for five minutes to dry and remove the solvent, and then, pressed by a roll press machine at room temperature to form a positive electrode mixture so as to prepare a positive electrode.

Next, the positive electrode was immersed in propylene carbonate as a nonaqueous solvent used in a nonaqueous electric storage element, to evaluate the adhesion of the positive electrode mixture; no floating or peeling of the positive electrode mixture was observed, and the positive electrode mixture stuck firmly on the aluminum foil. Thus, it was confirmed that the polyphenylene sulfide particles function as a binder.

### Application Example 14

A composite for forming a negative electrode was prepared by mixing 25 mass % of the negative electrode active material (2); 15 mass % of an NMP dispersion of 5 mass % of polyphenylene sulfide particles; 5 mass % of an NMP dispersion of 20 mass % of carbon black (manufactured by Mikuni-Color Ltd.) as a conductive aid; and 55 mass % of a mixed solution of NMP and propylene glycol (mass ratio of 7:3).

Here, as being insoluble in NMP and in propylene glycol, polyphenylene sulfide exists as particles in the composite for forming a negative electrode, and the mixed solution of NMP and propylene glycol functions as a dispersion medium.

The viscosity of the composite for forming a negative electrode was 14 mPa·s.

The particle-size distribution of the composite for forming a negative electrode was measured, and it was found that the distribution had a peak at 0.7 μm and the D₉₀ was 1.4 μm. After 24 hours, the particle-size distribution of the composite for forming a negative electrode was measured again; no change was observed in the particle-size distribution, and the storage stability of the composite for forming a negative electrode was satisfactory.

The composite for forming a negative electrode was printed on aluminum foil as a positive electrode substrate, by using an ink-jet printer EV2500 (manufactured by Ricoh Co., Ltd.). At this time, it was possible to continuously discharge the composite for forming a negative electrode, and the discharge stability of the composite for forming a negative electrode was satisfactory. Also, by printing the composite for forming a negative electrode eight times, it was possible to form a coating film corresponding to around 2.5 mg/cm² of the negative electrode mixture, and the printing efficiency of the composite for forming a negative electrode was satisfactory.

The aluminum foil having the coating film formed was placed in a dryer at 120° C. for five minutes to dry and remove the solvent, and then, pressed by a roll press machine at room temperature to form a negative electrode mixture so as to prepare a negative electrode.

Next, the negative electrode was immersed in propylene carbonate as a nonaqueous solvent used for a nonaqueous electric storage element to evaluate the adhesion of the negative electrode mixture; no floating or peeling of the negative electrode mixture was observed, and the negative electrode mixture stuck firmly on the aluminum foil. Thus, it was confirmed that the polyphenylene sulfide particles function as a binder.

Table 2 lists the compositions of the respective composites for forming an electrode.

TABLE 2

| | | | | Macromolecular particle | | | | |
|---|---|---|---|---|---|---|---|---|
| | | | | | Mean | | Glass | |
| | | Active material | | | particle | Melting | transition | |
| | Dispersion medium | | Content | | diameter | point | Temperature | Viscosity |
| | Species | Species | [mass %] | Species | [μm] | [° C.] | [° C.] | [mPa · s] |
| Appl. Ex. 1 | Water/Propylene glycol | Positive electrode | 25 | PVDF | 0.5 | 151 | — | 15 |
| | | active material (1) | | | | | | |
| Appl. Ex. 2 | Water/Propylene glycol | Positive electrode | 25 | Acrylic resin | 0.15 | — | −61 | 16 |
| | | active material (1) | | | | | | |
| Appl. Ex. 3 | Water/Propylene glycol | Negative electrode | 15 | Styrene | 0.15 | — | −5 | 14 |
| | | active material (1) | | butadiene | | | | |
| | | | | copolymer | | | | |
| Appl. Ex. 4 | Water/Cyclohexanone | Positive electrode | 25 | PPS | 0.5 | 285 | 85 | 14 |
| | | active material (1) | | | | | | |
| Appl. Ex. 5 | Water/NMP | Positive electrode | 25 | PPS | 0.5 | 285 | 85 | 13 |
| | | active material (1) | | | | | | |
| Appl. Ex. 6 | Water/Cyclohexanone | Positive electrode | 25 | PBT | 0.5 | 224 | 34 | 10 |
| | | active material (1) | | | | | | |
| Appl. Ex. 7 | Water/3-methoxy-N, | Positive electrode | 25 | PPS | 0.5 | 285 | 85 | 12 |
| | N-dimethylpropionamide | active material (1) | | | | | | |
| Appl. Ex. 8 | NMP/Propylene glycol | Positive electrode | 25 | PPS | 0.4 | 285 | 85 | 14 |
| | | active material (1) | | | | | | |
| Appl. Ex. 9 | NMP/Propylene glycol | Positive electrode | 25 | PPS | 0.4 | 285 | 85 | 16 |
| | | active material (2) | | | | | | |
| Appl. Ex. 10 | NMP/Propylene glycol | Positive electrode | 25 | PPS | 0.4 | 285 | 85 | 13 |
| | | active material (3) | | | | | | |
| Appl. Ex. 11 | NMP/Propylene glycol | Positive electrode | 25 | PPS | 0.4 | 285 | 85 | 10 |
| | | active material (4) | | | | | | |
| Appl. Ex. 12 | NMP/Propylene glycol | Positive electrode | 25 | PPS | 0.4 | 285 | 85 | 12 |
| | | active material (5) | | | | | | |
| Appl. Ex. 13 | NMP/Propylene glycol | Positive electrode | 25 | PPS | 0.4 | 285 | 85 | 11 |
| | | active material (6) | | | | | | |
| Appl. Ex. 14 | NMP/Propylene glycol | Negative electrode | 25 | PPS | 0.4 | 285 | 85 | 14 |
| | | active material (2) | | | | | | |
| Comp. Ex. 1 | Water | Positive electrode | 25 | — | — | — | — | 18 |
| | | active material (1) | | | | | | |
| Comp. Ex. 2 | Water/Propylene glycol | Positive electrode | 5 | — | — | — | — | 12 |
| | | active material (1) | | | | | | |
| Comp. Ex. 3 | Water/NMP | Positive electrode | 25 | — | — | — | — | 14 |
| | | active material (1) | | | | | | |
| Comp. Ex. 4 | NMP | Positive electrode | 10 | — | — | — | — | 11 |
| | | active material (1) | | | | | | |

<Discharge Capacity Per Unit Mass of Active Material>

Punching was applied to a positive electrode (or a negative electrode) to obtain a round-shaped electrode having a diameter of 16 mm, and then, the round-shaped electrode is put into a coin-shaped can having the same shape as CR2032, together with a glass filter paper GA-100 (manufactured by ADVANTEC) as a separator, a nonaqueous electrolytic solution, and lithium having a thickness of 200 μm as a counter electrode, to prepare a nonaqueous electric storage element. Here, the nonaqueous electrolytic solution was a mixed solution of ethylene carbonate (EC), dimethyl carbonate (DMC), and ethyl methyl carbonate (EMC) (mass ratio of 1:1:1) in which 1.5 mol/L of LiPF₆ was dissolved.

At room temperature (25° C.), by using a charge-discharge test system TOSCAT-3100 (manufactured by TOYO SYSTEM Co., LTD.), with a constant current of 0.1 mA/cm², within a predetermined voltage range (see Table 3), charging and discharging were performed on the nonaqueous storage element three times, to calculate the discharge capacity of the active material per unit mass from the discharge capacity obtained for the third time.

Table 3 lists some of the active materials used in the corresponding nonaqueous electric storage elements, along with an actually measured value and the catalog value of the discharge capacity per unit mass of each of the active materials. Note that since the positive electrode active material (1) is not a commercial product, a theoretical capacity is presented instead of the catalog value.

TABLE 3

| | Active material | | | Voltage |
|---|---|---|---|---|
| | | Discharge capacity per | | range when |
| | | unit mass [mAh/g] | | charging/ |
| | | Measured | Catalog | discharging |
| | Species | value | value | [V] |
| Appl. | Positive | 120 | 132 | 2.5-4.2 |
| Ex. 8 | electrode | | | |
| | active | | | |
| | material (1) | | | |
| Appl. | Positive | 161 | 170 | 2.7-3.8 |
| Ex. 9 | electrode | | | |
| | active | | | |
| | material (2) | | | |
| Appl. | Positive | 130 | 140 | 3.0-4.2 |
| Ex. 10 | electrode | | | |
| | active | | | |
| | material (3) | | | |
| Appl. | Positive | 175 | 180-200 | 3.0-4.2 |
| Ex. 11 | electrode | | | |
| | active | | | |
| | material (4) | | | |
| Appl. | Positive | 161 | 160-170 | 3.0-4.2 |
| Ex. 12 | electrode | | | |
| | active | | | |
| | material (5) | | | |
| Appl. | Positive | 105 | 100-120 | 3.0-4.2 |
| Ex. 13 | electrode | | | |
| | active | | | |
| | material (6) | | | |
| Appl. | Negative | 160 | 175 | 1.0-2.0 |
| Ex. 14 | electrode | | | |
| | active | | | |
| | material (2) | | | |

From Table 3, it can be understood that each of the nonaqueous electric storage elements of Application examples 8 to 14 has a discharge capacity per unit mass of the active material virtually the same as the theoretical capacity or the catalog value.

### CITATION LIST

### Patent Literature

[PTL 1] Japanese Unexamined Patent Publication No. 2009-152180

[PTL 2] Japanese Unexamined Patent Publication No. 2010-97946

The present application is based on and claims the benefit of priority of Japanese Priority Application No. 2018-047355 filed on Mar. 14, 2018, and Japanese Priority Application No. 2019-003695 filed on Jan. 11, 2019, with the Japanese Patent Office, the entire contents of which are hereby incorporated by reference.

1. A composite for forming an electrode, comprising:
an active material; and
macromolecular particles,
wherein the composite can be discharged by an inkjet method.

2. The composite for forming the electrode as claimed in claim 1, further comprising:
a dispersion medium.

3. The composite for forming the electrode as claimed in claim 1, wherein the macromolecular particles have an average particle diameter of 0.01 to 1 μm.

4. The composite for forming the electrode as claimed in claim 1, wherein a content of the active material is greater than or equal to 10 mass %.

5. The composite for forming the electrode as claimed in claim 1, wherein the active material is one or more species selected from among a group consisting of a lithium-containing transition metal oxide, a lithium-containing transition metal phosphate compound, and a carbon material.

6. The composite for forming an electrode as claimed in claim 5, wherein the active material is the lithium-containing transition metal phosphate compound compounded with the carbon material.

7. The composite for forming the electrode as claimed in claim 1, wherein a viscosity at 25° C. is less than or equal to 200 mPa·s.

8. The composite for forming the electrode as claimed in claim 1, wherein the active material contains lithium, and is nonaqueous.

9. A method of manufacturing an electrode, the method comprising:
discharging the composite for forming the electrode as claimed in claim 1 onto an electrode substrate.

10. The method of manufacturing the electrode as claimed in claim 9, the method further comprising:
pressing the electrode substrate onto which the composite for forming the electrode has been discharged.

11. A method of manufacturing a nonaqueous electric storage element, the method comprising:
manufacturing an electrode by using the method of manufacturing the electrode as claimed in claim 9.

12. A composite for forming an electrode, comprising:
an active material; and
macromolecular particles,
wherein a viscosity at 25° C. is less than or equal to 200 mPa·s,
wherein the macromolecular particles have an average particle diameter of 0.01 to 1 μm, and
wherein a content of the active material is greater than or equal to 10 mass %.

13. A composite for forming an electrode to be used for forming an electrode of a nonaqueous electric storage element, comprising:
an active material; and
macromolecular particles.
